(19) United States
(12) Patent Application Publication
(10) Pub. No.: US 2002/0088944 A1
(43) Pub. Date: Jul. 11, 2002

(54) Charge exchange device for charged particle accelerator

(76) Inventors: Marvin R. LaFontaine, Kingston, NH (US); Paul Murphy, Reading, MA (US); Paul Barrett, Kingston, NH (US)

Correspondence Address: Gary L. Loser, Esq., Varian Semiconductor Equipment Associates, Inc., 35 Dory Road, Gloucester, MA, 01930, US

(21) Appl. No.: 09/755,554

(22) Filed: Jan. 5, 2001

(51) Int. Cl. H01J 27/00

(52) U.S. Cl. 250/423 R

(57) ABSTRACT

A charge exchange device, typically used in an ion beam accelerator, includes a charge exchange tube defining a charge exchange chamber and beam ports for allowing an ion beam to enter and exit the charge exchange tube, a containment tube mounted external to the charge exchange tube, the containment tube having an entrance port for a charge exchange material, and at least one intermediate tube mounted between the charge exchange tube and the containment tube. The charge exchange tube and the at least one intermediate tube have at least one set of flow ports that are aligned on opposite sides of the charge exchange chamber to permit columnated flow of the charge exchange material into and through the charge exchange chamber. Leakage of the charge exchange material through the beam ports is reduced in comparison with prior art charge exchange devices.

### FIELD OF THE INVENTION

The present invention relates to charge exchange devices used in charged particle accelerators and, more particularly, to charge exchange devices that produce columnated flow of a gas into a charge exchange chamber.

### BACKGROUND OF THE INVENTION

Tandem accelerators are widely used for accelerating ions to high energies and in some cases implanting ions in semiconductor wafers. Tandem accelerators either generate a negative ion beam, which is directed toward a positive terminal, or a positive ion beam, which is directed toward a negative terminal. The first stage of the tandem accelerator accelerates the ion beam by directing the beam toward a high voltage terminal and through a charge exchange device, or ion stripper. The ion beam passes through the bore of the charge exchange device and encounters a charge exchange material, which may be a solid film, a vapor, or a gas. The result of the encounter between the ions and the charge exchange material is that electrons are either stripped from or added to the ions in the ion beam, thereby reversing the charge of the beam; negative ions in a negative ion beam become positive, and positive ions in a positive ion beam become negative. The ion beam then leaves the charge exchange device and is further accelerated from the high-voltage terminal toward ground, thus acquiring energy both before and after the terminal. The beam may then be focussed and directed at a semiconductor wafer to implant ions into the wafer.

Prior art charge exchange devices typically include a charge exchange tube with an internal diameter of approximately one centimeter (cm) to accommodate the diameter of the ion beam. The charge exchange tube is evacuated to remove substantially all ambient gas, and a change exchange material is then leaked into the charge exchange chamber tube through a hole at the center of the tube. The gas pressure in the charge exchange tube is on the order of 10⁻³ to 10⁻⁵ torr. The pressure is higher at the center where gas is leaked into the tube and lower at the ends of the tube where the beam enters and exits the tube. The integral of pressure along the length of the tube is known as the “pressure-length”. The pressure-length must be at least a minimum value, typically on the order of 10⁻⁵ torr-cm, to achieve sufficient interaction between the charge exchange material and the ion beam. The ion beam, which passes through the tube axially, loses or gains electrons through grazing collisions with the gas molecules. The gas then migrates to the ends of the tube, where it escapes through the ion beam entrance and exit ports.

The escaped gas may create an external hazard, contaminate the accelerator system, and reduce reuse of the gas. Furthermore, when the gas leaks to the beamline, the ions in the ion beam may collide with the charge exchange gas molecules in an uncontrolled manner. The ion beam then contains ions with different charge states, which are accelerated to different energies and have different final velocities. As the ion beam is later passed through a magnet to remove unwanted species, the ions with different charge states result in reduced beam current and reduced throughput.

The amount of gas which escapes increases with the pressure of the gas in the charge exchange chamber and with the third power of the change exchange tube diameter. Since the amount of escaped gas increases significantly with an increase in the internal diameter of the tube, the internal diameter must be kept as small as possible. However, the size of the ion beam is limited by a tube having a small diameter. In a low-current mode, the tandem accelerator may transport a small ion beam, approximately one cm in diameter, through the charge exchange chamber. In a medium-or high-current mode, the tandem accelerator may transport a larger beam of approximately 2.5 cm in diameter, and the charge exchange chamber may not be required for accelerator operation. To accommodate the larger beam, some systems may mechanically move the charge exchange chamber out of the beamline, which is mechanically unreliable. Moreover, a movable charge exchange chamber requires seals and bearings which may fail and which are themselves mechanically unreliable. Furthermore, changing the mode of the tandem accelerator requires accelerator downtime. Alternatively, a larger diameter charge exchange chamber may be used to accommodate both the large and small beam diameters. However, a larger diameter charge exchange chamber has a corresponding increase in leakage of the charge exchange gas. Thus, selection of tube diameter is a compromise between factors including, but not limited to, minimizing escaped gas, accommodating the full beam diameter, and maintaining mechanical reliability and simplicity.

Prior art devices and systems, shown for example in FIG. 6, reduce the escape of the charge exchange gas by surrounding the charge exchange tube with a single outer tube and removing gas from the outer tube with a vacuum pump . Vacuum pumping of the outer tube may recirculate part of the escaping gas. However, the charge exchange tube and the outer tube have beam exit and entrance ports which allow the gas to escape, and thus, have the disadvantages of other prior art systems.

The prior art also discloses directing an ultra-sonic stream of vapor into a charge-reversal area. The vapor is then collected and condensed on the opposite side of the ion beam for recycling. However, these prior art systems utilize charge exchange materials in the form of metal vapors, rather than inert gases, and thus do not collect a gas, but rather, collect the vapor by condensing it on a cool surface opposite the stream nozzle. Furthermore, these systems use only a single narrow stream, and thus, do not achieve a high concentration of the exchange vapor, and thereby limit the amount of vapor available for interaction with the beam.

### SUMMARY OF THE INVENTION

The present invention relates to charge exchange devices and methods which overcome one or more of the above-noted and other disadvantages of prior art charge exchange devices. The charge exchange devices achieve reduced leakage of the charge exchange material through the particle beam entrance and exit ports by providing at least one columnated molecular flow, or gas jet, into and through the charge exchange chamber. The columnated molecular flow is collected on the opposite side of the charge exchange chamber. Preferably, the charge exchange device provides a plurality of columnated flows that intersect in the charge exchange chamber.

According to a first aspect of the invention, a charge exchange device is provided. The charge exchange device comprises a charge exchange tube defining a charge exchange chamber and beam ports for allowing an ion beam to enter and exit the charge exchange tube, a containment tube mounted external to the charge exchange tube, the containment tube having an entrance port for a charge exchange material, and at least one intermediate tube mounted between the charge exchange tube and the containment tube. The charge exchange tube and at least one intermediate tube have at least one set of flow ports that are aligned on opposite sides the charge exchange chamber to permit columnated flow of the charge exchange material into and through the charge exchange chamber.

According to another aspect of the invention, a charge exchange device is provided for use in an ion beam accelerator. The charge exchange device comprises a charge exchange tube defining a charge exchange chamber and beam ports for allowing the ion beam to enter and exit the charge exchange chamber, means for creating columnated flow of a charge exchange material into and through the charge exchange chamber, and means for collecting the columnated flow from the charge exchange chamber.

According to a further aspect of the invention, a method is provided for charge exchange with an ion beam. The method comprises the steps of transporting the ion beam through a charge exchange chamber, directing a columnated molecular flow of a charge exchange material into the charge exchange chamber, and collecting the columnated flow of the charge exchange material as the charge exchange material exits the charge exchange chamber.

Various embodiments of the present invention provide certain advantages and overcome certain drawbacks of prior devices and systems. Embodiments of the invention may not share the same advantages and those that do may not share them under all circumstances. The present invention provides numerous advantages, including the noted advantage of reducing leakage of the charge exchange material through the beam entrance and exit ports.

Further features and advantages of the present invention as well as the structure and method of making various embodiments of the present invention are described in detail below with reference to the accompanying drawings.

### BRIEF DESCRIPTION OF THE DRAWINGS

Various embodiments of the invention are now described, by way of example, with reference to the accompanying drawings, in which:

FIG. 1 is a functional block diagram of an ion implanter according to one aspect of the invention;

FIG. 2 is a perspective cross-sectional view of an embodiment of a charge exchange device in accordance with the invention;

FIG. 3 is a cross-sectional view of the charge exchange device shown in FIG. 2, as viewed along the beamline;

FIG. 4 is a cross-sectional view of the charge exchange device shown in FIG. 2, as viewed perpendicular to the beamline;

FIG. 5 is a perspective view of the charge exchange device shown in FIG. 2; and

FIG. 6 is a charge exchange device of the prior art.

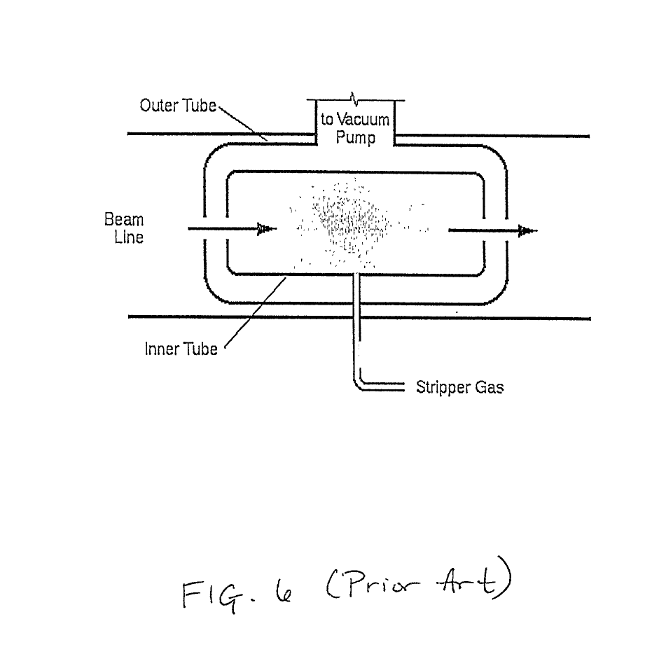

### DETAILED DESCRIPTION

The present invention is related to devices and methods for exposing an ion beam to a charge exchange material. The disclosed devices and methods create a columnated molecular flow, or gas jet, of the charge exchange material into and through a charge exchange chamber. The device includes a containment tube, at least one intermediate tube, and a charge exchange tube which defines a charge exchange chamber. The charge exchange tube and each intermediate tube contain aligned flow ports which produce a columnated molecular flow into and through the charge exchange chamber as described below. The term “molecular flow” is used herein to indicate a range of pressures in which the charge exchange material molecules are more likely to collide with the wall of an enclosure than to collide with another charge exchange material molecule. A molecular flow is generally obtained at pressures less than 10⁻³ torr. The term “columnated” is used herein to describe a flow of charge exchange material molecules in substantially parallel or nearly parallel directions.

Although the invention is discussed below in connection with use in a positive terminal tandem accelerator with a gaseous charge exchange material, the present invention may be used with other types of accelerators and with non-solid charge exchange materials.

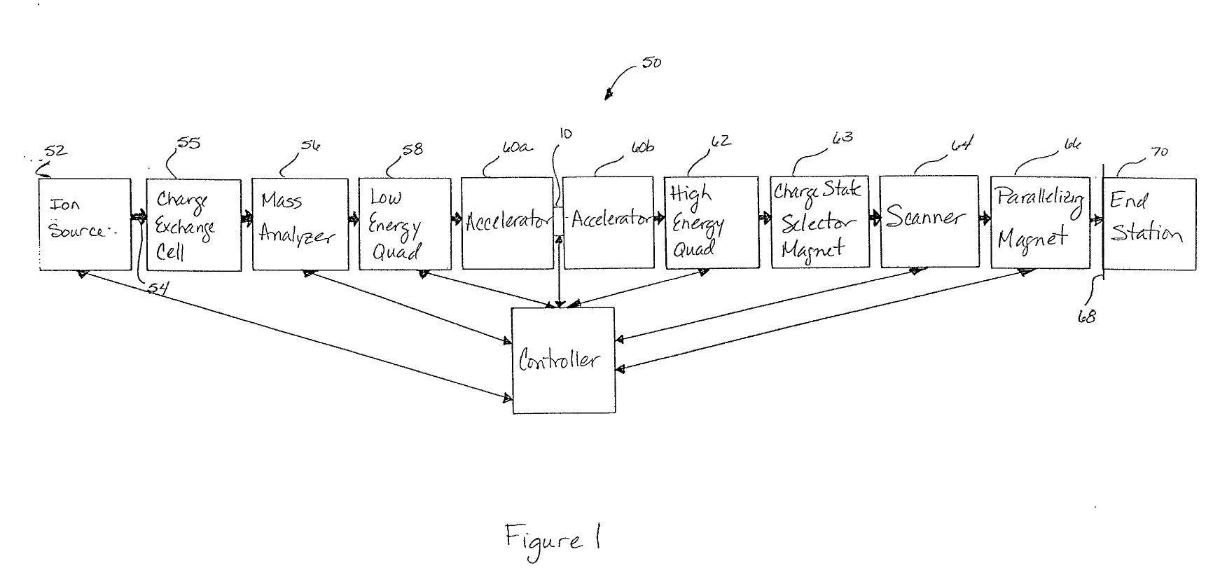

An embodiment of an ion implanter incorporating a tandem accelerator is shown in FIG. 1. An ion implanter 50 includes an ion source 52 which generates ions of a source material. Ions from the source 52 are accelerated by application of an extraction voltage to form an ion beam 54 of positive ions. The positive ions then pass through a magnesium (Mg) charge-exchange cell 55 to form a negative beam. The ion beam 54 at this stage includes multiple species and charge states of the ionized source material. A particular species is selected by a mass analyzer 56. The ion beam 54 is then conditioned in a low energy quadrupole 58, which focuses and centers the ion beam 54 prior to entering a tandem accelerator including an accelerator 60a, a charge exchange device 10 and an accelerator 60b. In accelerator 60a, ion beam 54 is accelerated toward a high voltage positive terminal and through charge exchange device 10. The ion beam 54 passes through a charge exchange chamber in the charge exchange device 10 and encounters a charge exchange material where electrons are stripped from the ions in the negative ion beam 54, thereby causing the ions to become positive. The charge exchange material may include, but is not limited to, argon and nitrogen. The positively charged ion beam 54 then leaves the charge exchange device 10 and is further accelerated from the high voltage terminal toward ground through accelerator 60b. After the ion beam 54 leaves the accelerator 60b, it is again conditioned by a high energy quadrupole 62 which focuses the beam 54 into a charge-selector magnet (filter) 63. The filter magnet 63 passes the ion beam to the entrance of a scanner 64. The scanner 64 scans the ion beam 54 across the surface of a wafer 68 positioned in an end station 70. A parallelizing magnet 66 is provided to parallelize the scanned ion beam 54 prior to incidence on wafer 68.

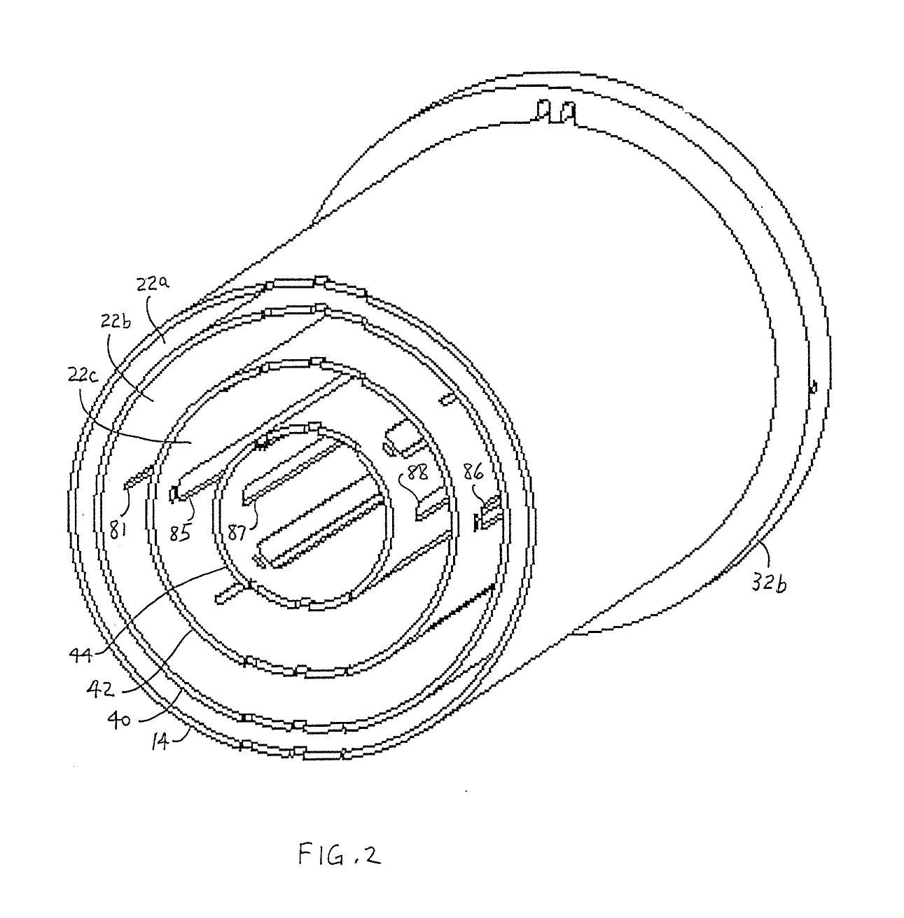

FIGS. 2-5 illustrate one embodiment of charge exchange device 10. Charge exchange device 10 includes a charge exchange tube 12, a containment tube 14, and one or more intermediate tubes between the charge exchange tube 12 and the containment tube 14. (The charge exchange tube 12 is not shown in FIG. 2.) The embodiment of FIGS. 2-5 includes intermediate tubes 40, 42 and 44. Preferably, charge exchange tube 12, containment tube 14, and intermediate tubes 40, 42 and 44 are cylindrical, are centered on beamline 24 and are concentric. Although the invention is described in connection with the charge exchange tube, the intermediate tubes, and the containment tube being cylindrical, of the same shape, and concentric, it should be appreciated that the present invention is not limited in these respects, and that the present invention may utilize other tube shapes which avoid sharp edges that would promote electrical discharge, particularly near the high voltage terminal of the tandem accelerator. Furthermore, it should be appreciated that the tubes need not be the same shape or mounted concentrically.

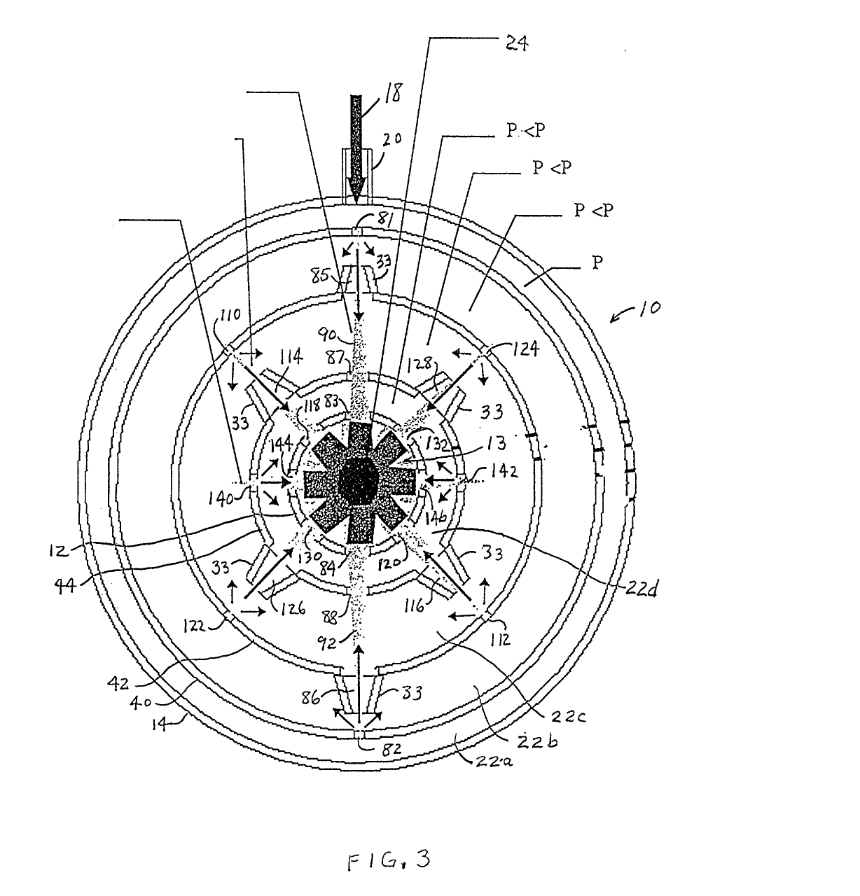

Charge exchange tube 12 defines a charge exchange chamber 13. Intermediate tubes 40, 42 and 44 and charge exchange tube 12 are provided with at least one set of primary flow ports. The flow ports in a set are aligned along a diameter of charge exchange device 10 on opposite sides of beamline 24 to allow columnated flow of the charge exchange material into and through charge exchange chamber 13. In the embodiment of FIGS. 2-5, a set of primary flow ports includes flow ports 81 and 82 in intermediate tube 40, flow ports 85 and 86 in intermediate tube 42, flow ports 87 and 88 in intermediate tube 44 and flow ports 83 and 84 in charge exchange tube 12. The primary flow ports 81-88 are radially aligned along a diameter of the charge exchange device, as best shown in FIG. 3. Flow ports 81, 85, 87 and 83 are located on one side of beamline 24 and define a first flow path to and from charge exchange chamber 13. Flow ports 82, 86, 88 and 84 are located on the opposite side of beamline 24 and define a second flow path to and from charge exchange chamber 13. The primary flow ports 81 88 thus define paths for two oppositely directed columnated flows, or jets, of the charge exchange material into and through charge exchange chamber 13, as described below.

A charge exchange material 18, in a gaseous state, is fed through a gas entrance port 20 into containment tube 14, producing a gas concentration Nₐ in an annular space 22a between containment tube 14 and intermediate tube 40. The gas concentration Nₐ produces a gas pressure Pₐ in annular space 22a, preferably in a range of 1 to 10 torr, and more preferably approximately 8 torr. Although the invention is described as having gas entrance port 20 feeding gas directly into annular space 22a, the gas entrance port may be located on any of the intermediate tubes 40, 42, 44.

The charge exchange material 18 passes from annular space 22a through the flow ports 81 and 82 with a Lambertian (Cosine) distribution into an annular space 22b between intermediate tubes 40 and 42. Flow ports 85 and 86 in intermediate tube 42 allow the radially-moving molecules of the charge exchange material 18 to pass from annular space 22b to an annular space 22c between intermediate tubes 42 and 44; flow ports 87 and 88 allow radially-moving molecules of charge exchange material 18 to pass from annular space 22c to an annular space 22d between intermediate tube 44 and charge exchange tube 12; and flow ports 83 and 84 allow radially-moving molecules of charge exchange material 18 to pass from annular space 22d to the charge exchange chamber 13. Thus, radially aligned flow ports 81-88 permit columnated molecular flow of the charge exchange material 18 toward beamline 24. The non-radially-moving molecules of charge exchange material do not pass through the flow ports and are removed from the annular spaces by a vacuum pump, as described below.

Annular space 22b has a gas concentration N_{b} which is less than the gas concentration Nₐ in annular space 22a, annular space 22c has a gas concentration N_{c} which is less than the gas concentration N_{b}, and annular space 22d has a gas concentration N_{d} which is less than the gas concentration N_{c}. The gas concentrations Nₐ, N_{b}, N_{c}, N_{d} correspond to gas pressures Pₐ, P_{b}, P_{c}, P_{d}, in annular spaces 22a, 22b, 22c, 22d, respectively, which decrease from annular space 22a to annular space 22d. The pressure P_{d} in annular space 22d and the pressure within the charge exchange tube 12 are preferably within a range of about 10⁻³ to 10⁻⁵ torr and allow molecular flow. The pressure differential from outer annular space 22a to charge exchange chamber 13 may be produced by vacuum pumping of the charge exchange device as described below.

The configuration of the charge exchange device 10 produces a first columnated flow 90, or gas jet, of charge exchange material 18 through radially aligned flow ports 81, 85, 87 and 83 toward charge exchange chamber 13 and a second columnated flow 92, or gas jet, of charge exchange material 18 through radially aligned flow ports 82, 86, 88 and 84 toward charge exchange chamber 13. The first and second columnated flows move in opposite directions into and through the charge exchange chamber 13. Molecules of the charge exchange material 18 are in a molecular flow regime, wherein the molecules of the oppositely directed first and second columnated flows pass without substantial probability of collision. Each of the oppositely directed columnated flows passes through charge exchange chamber 13 and exits from charge exchange chamber 13 through the aligned flow ports on the opposite side of charge exchange rube 12. As a result, leakage of the charge exchange material through the ends of charge exchange tube 12 is limited. The columnated flows through charge exchange chamber 13 provide a sufficient density of charge exchange material 18 to achieve the desired charge exchange between the charge exchange material 18 and the ion beam 54.

The pressure of the charge exchange material in charge exchange chamber 13 is a tradeoff between a sufficiently high pressure to achieve the desired charge exchange with the ion beam and a sufficiently low pressure to limit adverse effects on the ion beam, such as beam blockage and undesired charge exchange. Preferably, the pressure of charge exchange material 18 in the charge exchange chamber 13 is in a range of about 10⁻³ to 10⁻⁵ torr.

Intermediate tubes 40, 42 and 44 and charge exchange tube 12 may be provided with additional flow ports for defining additional paths for columnated flow of the charge exchange material into and through charge exchange chamber 13. In the embodiment of FIGS. 2-5, a first secondary set of aligned flow ports includes flow ports 110 and 112 in intermediate tube 42, flow ports 114 and 116 in intermediate tube 44 and flow ports 118 and 120 in charge exchange tube 12. A second secondary set of aligned flow ports includes flow ports 122 and 124 in intermediate tube 42, flow ports 126 and 128 in intermediate tube 44 and flow ports 130 and 132 in charge exchange tube 12. A tertiary set of aligned flow ports includes flow ports 140 and 142 in intermediate tube 44 and flow ports 144 and 146 in charge exchange tube 12. The flow ports in each set of flow ports are radially aligned along a diameter of the charge exchange device and define paths for two oppositely directed columnated flows of the charge exchange material into and through charge exchange chamber 13. In the embodiment of FIGS. 2-5, the four sets of flow ports are equiangularly spaced with respect to beamline 24. Thus, paths are provided for eight columnated flows of the charge exchange material into and through charge exchange chamber 13. The multiple columnated flows intersect within charge exchange chamber 13 and increase the density of the change exchange material in charge exchange chamber 13, while limiting leakage of the charge exchange material from the ends of charge exchange tube 12.

Although the charge exchange device is described as having three intermediate tubes 40, 42, 44, one or more intermediate tubes may be utilized. The number of intermediate tubes between containment tube 14 and charge exchange tube 12 is limited by the maximum allowable size of the charge exchange device 10. At least one intermediate tube 40 is required between charge exchange tube 12 and containment tube 14 to permit columnated molecular flow of the charge exchange material into and through the charge exchange chamber 13.

In a preferred embodiment, the charge exchange tube 12 has four pairs of radially aligned flow ports to permit columnated flows into and through the charge exchange chamber 13. Additional flow ports in charge exchange tube 12 would permit additional columnated flows into charge exchange chamber 13. However, the flow would be less columnated, since additional flow ports would increase cross-flow of charge exchange material 18 in each annular space and in the charge exchange chamber. Cross-flow is non-radial flow of the charge exchange material within the annular spaces and the charge exchange chamber. The additional cross-flow reduces flow columnation.

In the embodiment of FIGS. 2-5, the number of flow ports is greater on intermediate tubes that are closer to charge exchange chamber 13. Thus, outermost intermediate tube 40 has two flow ports, middle intermediate tube 42 has six flow ports, and innermost intermediate tube 44 has eight flow ports. More particularly, the outermost flow ports of the set of primary flow ports are in intermediate tube 40, the outermost flow ports of the two sets of secondary flow ports are in intermediate tube 42, and the outermost flow ports of the set of tertiary flow ports are in intermediate tube 44. This configuration provides a relatively large number of flow paths into charge exchange chamber 13, while limiting cross-flow in the outer annular spaces 22a and 22b. As a result, a relatively high volume columnated flow of charge exchange material into and through charge exchange chamber 13 is achieved.

The molecules of charge exchange material 18 in charge exchange chamber 13 pass through ion beam 54 and change the charge state of ion beam 54. Each columnated flow of charge exchange material 18 then exits the charge exchange chamber 13 through the flow ports on the opposite side of charge exchange tube 12. Thus, radially-moving molecules of charge exchange material which enter charge exchange chamber 13 through flow port 83 exit through flow port 84. Similarly, radially-moving molecules of charge exchange material which enter charge exchange chamber 13 through flow port 84 exit through flow port 83. Because most of the molecules of charge exchange material move through charge exchange chamber 13 in a columnated flow from flow port 83 to flow port 84 and from flow port 84 to flow port 83, a relatively small amount of the charge exchange material 18 escapes the charge exchange chamber 13 through the open ends of charge exchange tube 12. Each columnated flow of charge exchange material 18 is more likely to be captured by the opposing flow port in the charge exchange tube 12 than to escape from the charge exchange chamber 12 through ion beam entrance port 26 and ion beam exit port 28.

The molecules of charge exchange material 18 exiting the charge exchange chamber 13 through flow ports 83 and 84 enter one of the annular spaces, and through dispersion and collisions, the molecules may re-enter the columnated flow into the charge exchange chamber 13; or the molecules in each annular space may be pumped out from the ends of the annular spaces by a vacuum pump 31, as described below. The charge exchange material 18 may be recirculated through the entrance port 20 into annular space 22a.

The charge exchange device 10 preferably includes a mounting structure for mounting containment tube 14, intermediate tubes 40, 42, 44, and charge exchange tube 12 in fixed relative positions. In the embodiment of FIGS. 2-5, mounting structures 32a and 32b having the form of end caps are located at opposite ends of containment tube 14, intermediate tubes 40, 42, 44, and charge exchange tube 12. Mounting structures 32a and 32b may have circular grooves for receiving the ends of containment tube 14 and intermediate tubes 40, 42 and 44. Although the invention is described above with reference to mounting structures 32a and 32b at the ends of the tubes, the mounting and placement of the tubes may be maintained by any suitable structure including, but not limited to, spacers, brackets, supports, and struts in annular spaces 22a, 22b, 22c and 22d.

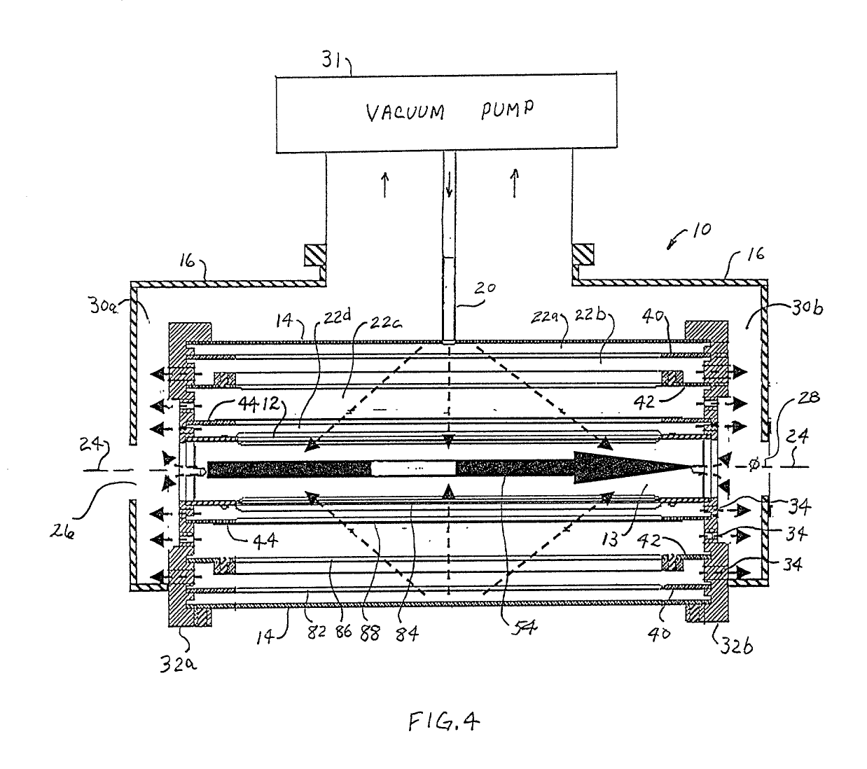

In one embodiment of the invention, one or more of the annular spaces 22a, 22b, 22c and 22d external to the charge exchange tube 12 may be enclosed to prevent or limit leakage of the charge exchange material 18 into the accelerator beamline. As shown in FIG. 4, annular space 22a is enclosed at opposite ends by mounting structures 32a and 32b. In another embodiment of the invention, one or more of annular spaces 22a, 22b, 22c and 22d may communicate with collection areas 30a and 30b at the ends of intermediate tubes 40, 42, 44 and containment tube 14. As shown in FIG. 4, annular spaces 22b, 22c and 22d may communicate through apertures 34 in mounting structures 32a and 32b with collection areas 30a and 30b, respectively. The collection areas 30a and 30b are defined between a vacuum manifold 16 and the outer surfaces of mounting structures 32a and 32b and containment tube 14. The vacuum manifold 16 may be connected to vacuum pump 31 to remove the charge exchange material 18. The charge exchange material 18 may be recycled and returned to the entrance port 20. Each annular space may communicate with a separate vacuum pump or alternatively, all or a group of annular spaces may communicate with a single vacuum pump. In one embodiment, vacuum pump 31 may be the Varian V300-HT vacuum pump. The vacuum pump 31 preferably has a pumping speed of at least 280 liters/second for nitrogen and argon.

As shown in FIG. 4, the vacuum manifold 16 includes an ion beam entrance port 26 and an ion beam exit port 28. Although a separate vacuum manifold 16 defines collection areas 30a and 30b in the embodiment of FIG. 4, the collection areas 30a and 30b may be defined by any suitable structure, including but not limited to a structure integrally formed with any and/or all of containment tube 14, intermediate tubes 40, 42, 44, and charge exchange tube 12. For example, the ends of containment tube 14 may be extended to form a toroid surrounding the ends of intermediate tubes 40, 42, and 44.

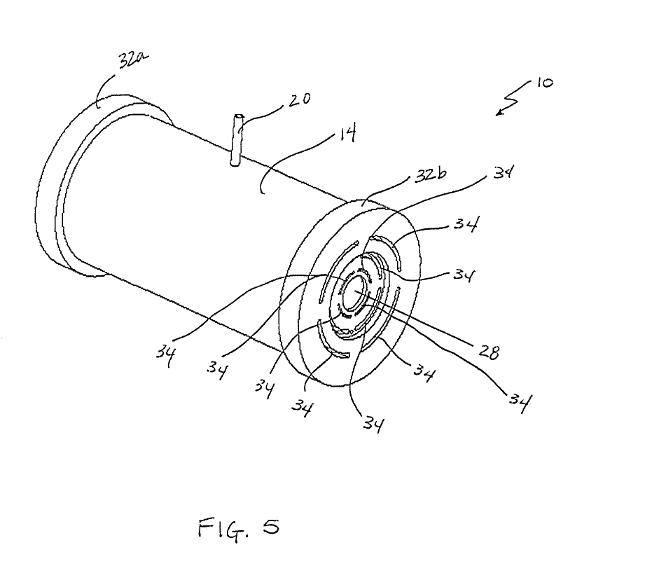

One or both of mounting structures 32a and 32b may include one or more apertures 34 (FIG. 5) to permit flow of the charge exchange material 18 from annular spaces 22b, 22c and 22d to the collection areas 30a and 30b. Mounting structures 32a and 32b preferably do not have flow apertures at the ends of annular space 22a to prevent the higher pressure charge exchange material 18 from flowing directly to the collection areas 30a and 30b. The radial dimension of the flow apertures 34 is preferably in a range of 0.05-0.38 inch and more preferably is approximately 0.25 inch. The number and size of apertures 34 in mounting structures 32a and 32b is selected to permit the charge exchange material to be removed by the vacuum pump 31. The mounting structures 32a and 32b also have beam entrance and exit ports.

The flow ports, including flow ports 81-88, 110-120, 122-132, and 140-146 in the embodiment of FIGS. 2-5, are shaped and sized to provide columnated flow of the exchange material 18 into and through charge exchange chamber 13 and to provide sufficient density of charge exchange material in charge exchange chamber 13 to achieve charge exchange with the ion beam. The degree of flow columnation depends on many factors, including but not limited to, the number of aligned flow ports, the width of the flow port along the circumference of the tube, the length of the flow port along the length of the tube, the spacing between the tubes, and the number of flow ports in each tube.

The degree of flow columnation is inversely related to the circumferential dimension of the flow ports, since a larger circumferential dimension creates a more diffused and less concentrated molecular flow. However, a larger flow port may be more efficient in capturing columnated flow from the opposite side of charge exchange chamber 13, thus presenting a tradeoff between the need for a small flow port to provide columnated flow and a large port for flow capture. The width of the flow ports is preferably within a range of 0.05 inch to 0.25 inch for a typical charge exchange tube of approximately 1.0 inch diameter, where the width of the flow ports is measured around the circumference of the tube.

The length of the flow ports is measured along the length of the tube. The flow ports may be circular to produce columnated flows in the form of pencil beams. However as shown in FIGS. 2 and 4, the length of each flow port is preferably greater than its width. Thus, the flow ports may have the form of slots that extend along the length of intermediate tubes 40, 42, 44 and charge exchange tube 12. The flow ports may extend over a major portion of the length of the tube, and in a preferred embodiment, may extend approximately one half to three-quarters of the length of intermediate tubes 40, 42, 44 and charge exchange tube 12. When the flow ports are placed near the beam entrance port 26 and the beam exit port 28 at the ends of the charge exchange tube 12, the efficiency of charge exchange material 18 recycling decreases and leakage into the accelerator beamline increases, as more charge exchange material 18 may escape through the beam entrance port 26 and the beam exit port 28. Thus, the flow ports may be substantially centered along the length of the tubes. The flow columnation is also inversely related to the length of the flow ports. However, forming the flow ports as slots provides a planar columnated flow, or gas jet, rather than a pencil beam columnated flow. The planar columnated flow allows the ion beam to travel through more charge exchange material 18 and to increase charge exchange within the charge exchange chamber 13. In the embodiment shown in FIGS. 2-5, the flow ports have lengths of approximately 7-8 inches. Alternatively, the flow ports may be formed as a series of circular or slot-shaped flow ports along the length of intermediate tubes 40, 42, 44 and charge exchange tube 12.

Although the flow ports are described as having the same shape and size, it will be understood that the flow ports may have different widths, lengths and shapes. For example, the flow port in intermediate tube 40 may have a width of approximately 0.19 inches and the flow ports may increase in width with decreasing distance from beamline 24, with the flow port in the charge exchange tube 12 being approximately 0.25 inches in width. As the flow ports increase in width toward the charge exchange chamber 13, more charge exchange material 18 is allowed to enter the charge exchange chamber 13, thereby increasing the concentration of charge exchange material 18. However, the flow is less columnated, and leakage of the charge exchange material 18 may increase. Alternatively, the flow ports may decrease in width with decreasing distance from beamline 24 to form a convergent flow of charge exchange material. This may reduce leakage, since the material may be collected more efficiently by the opposing flow ports. However, the concentration of the charge exchange material 18 in the charge exchange chamber 13 decreases, thus making it more difficult to achieve the desired pressure/concentration of the charge exchange material 18 in the charge exchange chamber 13.

The spacing between tubes 14, 40, 42, 44 and 12, which defines the radial dimensions of the annular spaces 22a, 22b, 22c and 22d, is correlated with the flow columnation and the amount of flow through the flow ports. The flow columnation through the flow ports is inversely related to the amount of molecular flow through the flow ports. Greater spacing between the tubes increases the parallelism of the columnated flow. However, less charge exchange material 18 flows through the flow ports and into the charge exchange chamber 13. For the embodiment shown in FIGS. 2-5, the annular spaces have radial dimensions within a range of about 0.5 to 2.0 inches. The spacing between the tubes is correlated with the width of the flow ports. The greater the width of the flow ports, the farther apart the tubes may be.

One or more of the flow ports in the charge exchange device may be configured with flanges that define a flare structure 33. The flanges may extend outwardly and/or inwardly from the edges of one or more flow ports in one or more of intermediate tubes 40, 42 and 44 and charge exchange tube 12. The flanges on opposite edges of a flow port may be parallel or may diverge with decreasing distance from beamline 24. The angle of divergence is preferably in a range of about 1° to 30°. The flare structure provides a columnated but slightly diverging flow of charge exchange material toward charge exchange chamber 13, while limiting non-radial cross-flow of the charge exchange material to adjacent flow ports. The flare structure also tends to increase collection of charge exchange material from flow ports on the opposite side of charge exchange chamber 13. The flanges may be attached to the respective tubes or may be formed as integral parts of the respective tubes. The flanges preferably have radial dimensions of about one half the radial spacing between tubes.

The charge exchange tube 12 may be formed of any suitable material, including, but not limited to, molybdenum, selected to limit electrical interaction with the ion beam 54. The containment tube 14, intermediate tubes 40, 42, 44, vacuum manifold 16, and flare structures 33 may be formed of any suitable material, including, but not limited to, stainless steel, that is non-reactive with the charge exchange material 18.

In an example of the embodiment shown in FIGS. 2-5, the charge exchange device 10 includes a charge exchange tube 12 of approximately 9.42 inches in length and having flow ports 83, 84 approximately 7.62 inches in length and centered along the length of the charge exchange tube 12. The charge exchange device 10 also includes intermediate tubes 40, 42, 44 having the same length as the charge exchange tube 12 and having flow ports approximately 7.62 inches in length. The containment tube 14 may be the same length as the charge exchange tube 12. Mounting structures 32a and 32b are attached to the ends of the containment tube 14, intermediate tubes 40, 42, 44, and the charge exchange tube 12. The mounting structures 32a and 32b include grooves 0.12 inches deep for supporting the containment tube 14, intermediate tubes 40, 42, 44, and the charge exchange tube 12 in the desired spacing and concentric with beamline 24. In one embodiment of the invention, annular space 22a has a radial dimension of 0.19 inches; annular space 22b has a radial dimension of 0.44 inches; annular space 22c has a radial dimension of 0.56 inches; and annular space 22d has a radial dimension of 0.25 inches. The internal diameter of the charge exchange tube 12 is preferably 1.0 inch. The mounting structures 32a and 32b have diameters of 5.13 inches and widths of 0.81 inches. The mounting structures 32a and 32b may completely enclose annular space 22a and may provide multiple apertures 34 at the ends of annular spaces 22b, 22c and 22d. The vacuum manifold 16 may be mounted external to the mounting structures 32a and 32b. Intermediate tube 42 may include at least one outwardly extending flare structure 33. The flare structure may have flanges approximately 0.22 inches wide and may have a divergence angle of approximately 20 degrees.

The invention may be configured for reduced leakage of charge exchange material 18 into the accelerator beamlines in comparison with prior art charge exchange devices. Alternatively, a charge exchange tube 12 with a larger internal diameter may be used with the same amount of leakage as prior art devices, while permitting a larger diameter ion beam to be used. In multiple energy implanters, such as the Varian VIISTA current and high-current implants, the internal diameter of the charge exchange tube 12 may accommodate the ion beam in each of these modes, thereby avoiding the need for mechanical movement of the charge exchange tube 12.

It will be understood that each of the elements herein, or two or more together, may be modified or may also find utility in other applications different from those described above. While particular embodiments of the invention have been illustrated and described, it is not intended to be limited to the details shown, since various modifications and substitutions may be made without departing in any way from the spirit of the present invention as defined by the following claims.

1. A charge exchange device comprising:
a. a charge exchange tube defining a charge exchange chamber and beam ports for allowing an ion beam to enter and exit the charge exchange tube;
b. a containment tube mounted external to the charge exchange tube, said containment tube having an entrance port for a charge exchange material; and
c. at least one intermediate tube mounted between the charge exchange tube and the containment tube;
d. wherein the charge exchange tube and the at least one intermediate tube have at least one set of flow ports that are aligned on opposite sides of the charge exchange chamber to permit columnated flow of the charge exchange material into and through the charge exchange chamber.

2. A charge exchange device as defined in claim 1, wherein said at least one intermediate tube comprises:
a plurality of spaced apart concentric tubes between the charge exchange tube and the containment tube.

3. A charge exchange device as defined in claim 1, wherein the pressure of the charge exchange material in the charge exchange chamber is in a range of 10⁻³ to 10⁻⁵ torr.

4. A charge exchange device as defined in claim 1, wherein said at least one set of flow ports comprises:
a plurality of sets of flow ports, wherein the flow ports in each set are aligned on opposite sides of the charge exchange chamber.

5. A charge exchange device as defined in claim 1, wherein said at least one intermediate tube comprises a plurality of intermediate tubes, wherein said at least one set of flow ports comprises two or more sets of flow ports; and wherein a number of flow ports in an innermost intermediate tube is greater than a number of flow ports in an outermost intermediate tube.

6. A charge exchange device as defined in claim 1, wherein the flow ports in said at least one set of flow ports are aligned to permit the columnated flow of the charge exchange material to enter the charge exchange chamber through flow ports on one side of the charge exchange chamber and to permit the columnated flow to exit the charge exchange chamber through flow ports on the opposite side of the charge exchange chamber.

7. A charge exchange device as defined in claim 1, wherein one or more of said flow ports are provided with a flare structure to limit cross-flow of the charge exchange material.

8. A charge exchange device as defined in claim 1, further comprising:
one or more mounting structures for maintaining the containment tube, the at least one intermediate tube and the charge exchange tube in fixed positions relative to each other.

9. A charge exchange device as defined in claim 8, wherein said mounting structures comprise:
first and second grooved structures mounted on opposite ends of said charge exchange tube, said containment tube and said at least one intermediate tube.

10. A charge exchange device as defined in claim 8, further comprising:
a vacuum pump connected through apertures in said mounting structures to spaces between said tubes.

11. A charge exchange device as defined in claim 1, wherein said charge exchange tube, said containment tube and said at least one intermediate tube are cylindrical and concentric.

12. A charge exchange device as defined in claim 11, wherein said flow ports are slot-shaped and have a long axial dimension.

13. A charge exchange device as defined in claim 12, wherein said flow ports are centered along the lengths of said tubes.

14. A charge exchange device as defined in claim 7, wherein said flare structure comprises:
flanges on opposite sides of a flow port, said flanges diverging with decreasing distance from the charge exchange chamber.

15. A charge exchange device as defined in claim 1, wherein said at least one intermediate tube comprises:
an outermost intermediate tube;
a middle intermediate tube; and
an innermost intermediate tube.

16. A charge exchange device as defined in claim 14, wherein said at least one set of flow ports comprises:
a first set of flow ports in said outermost, middle and innermost intermediate tubes, and said charge exchange tube, second and third sets of flow ports in said middle and innermost intermediate tubes and said charge exchange tube and a fourth set of flow ports in said innermost intermediate tube and said charge exchange tube.

17. A charge exchange device as defined in claim 1, further comprising a vacuum pump in communication with at least one space internal to the at least one intermediate tube.

18. A charge exchange device for use in an ion beam accelerator, the device comprising:
a. a charge exchange tube defining a charge exchange chamber and beam ports for allowing the ion beam to enter and exit the charge exchange chamber;
b. means for creating a columnated flow of a charge material into and through the charge exchange chamber; and
c. means for collecting the columnated flow of the charge exchange material as the columnated flow exits the charge exchange chamber.

19. A charge exchange device as defined in claim 18, wherein the means for creating and the means for collecting comprise at least one intermediate tube mounted between the charge exchange tube and the containment tube, and at least one set of flow ports in the charge exchange tube and the at least one intermediate tube, wherein the at least one set of flow ports are aligned on opposite sides of the charge exchange chamber.

20. A charge exchange device as defined in claim 18, wherein the means for creating a columnated flow creates a plurality of columnated flows into and through the charge exchange chamber, and the means for collecting a columnated flow collects the plurality of columnated flows exiting the charge exchange chamber.

21. A charge exchange device as defined in claim 18, wherein the means for creating allows the columnated flow to enter the charge exchange chamber on one side of the charge exchange chamber and the means for collecting allows the columnated flow to exit the charge exchange chamber on the opposite side of the charge exchange chamber.

22. A charge exchange device as defined in claim 19, wherein the flow ports in said at least one set of flow ports are aligned to permit the columnated flow of the charge exchange material to enter the charge exchange chamber through flow ports on one side of the charge exchange chamber and to permit the columnated flow to exit the charge exchange chamber through flow ports on the opposite side of the charge exchange chamber.

23. A charge exchange device as defined in claim 19, wherein one intermediate tube comprises a plurality of spaced apart concentric tubes.

24. A charge exchange device as defined in claim 18, wherein the means for creating include a flare structure to limit cross-flow of the charge exchange material.

25. A charge exchange device as defined in claim 18, further comprising:
a vacuum pump communicating with the means for collecting.

26. A charge exchange device as defined in claim 18, wherein the means for creating and the means for collecting extend along the axial dimension of the charge exchange tube.

27. A method for charge exchange with an ion beam, comprising the steps of:
a. transporting the ion beam through a charge exchange chamber;
b. directing a columnated molecular flow of a charge exchange material into the charge exchange chamber; and
c. collecting the columnated flow of the charge exchange material as the columnated flow exits the charge exchange chamber.

28. A method for charge exchange as defined in claim 27, wherein the step of directing comprises the step of allowing molecular flow through at least one set of flow ports that are aligned on opposite sides of the charge exchange chamber.

29. A method for charge exchange as defined in claim 27, wherein the step of collecting comprises the step of allowing columnated molecular flow through at least one set of flow ports that are aligned on opposite sides of the charge exchange chamber.

30. A method for charge exchange as defined in claim 27, further comprising the step of pumping uncolumnated flow of the charge exchange material.

31. A method for charge exchange as defined in claim 30, further comprising the step of recycling the pumped charge exchange material into the directed columnated flow into the charge exchange chamber.
